(19) United States
(12) Patent Application Publication
(10) Pub. No.: US 2024/0270285 A1
(43) Pub. Date: Aug. 15, 2024

(54) DRIVING BEHAVIOR-AWARE ADVANCED DRIVING ASSISTANCE SYSTEM

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); EMRAH AKIN SISBOT, Mountain View, CA (US); YASHAR ZEIYNALI FARID, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, Toyota-shi (JP)

(21) Appl. No.: 18/169,147

(22) Filed: Feb. 14, 2023

(51) Int. Cl. B60W 60/00

(52) U.S. Cl. CPC B60W 60/0051; B60W 2554/4046

(57) ABSTRACT

Driver assistance systems tend to imitate the driving behaviors of neighboring vehicles, and thus any resulting action(s) of the vehicle's driver assistance system will be influenced by such driving behaviors. If the driving behaviors are undesirable, such undesirable driving behaviors tend to propagate amongst neighboring vehicles. Systems and methods are provided for selective enablement or adjustment of a vehicle's driver assistance system, where the vehicle's driver assistance system can either be prohibited from being enabled, or when already in use, adjusting the default operation to compensate/offset/account for the undesirable driving behaviors that may be imitated by another vehicle. Moreover, coordinated efforts amongst a plurality of neighboring vehicles may be implemented to compensate/offset/account for undesirable driving behaviors.

### TECHNICAL FIELD

The present disclosure relates generally to driver assistance systems, and in particular, some implementations may relate to selective enablement of autonomous driving systems/features, such as an advanced driver-assistance system (“ADAS”) in light of the driving behavior of neighboring vehicles.

### DESCRIPTION OF RELATED ART

ADAS can refer to electronic systems that assist a vehicle operator while driving, parking, or otherwise maneuvering a vehicle. ADAS can increase vehicle and road safety by minimizing human error, and introducing some level of automated vehicle/vehicle feature control. Autonomous/automated driving systems (“ADS”) may go further than ADAS by leaving responsibility of maneuvering and controlling a vehicle to the autonomous driving systems. For example, an autonomous driving system may comprise some package or combination of sensors to perceive a vehicle's surroundings, and advanced control systems that interpret the sensory information to identify appropriate navigation paths, obstacles, road signage, etc.

### BRIEF SUMMARY OF THE DISCLOSURE

In accordance with one embodiment, a vehicle comprises an autonomous control system adapted to provide one or more commands to autonomously control one or more systems of the vehicle. The vehicle further comprises an autonomous control unit adapted to selectively enable the autonomous control system in response to a determination regarding whether a neighboring vehicle, whose associated driving data influences the autonomous control system of the vehicle, is exhibiting anomalous driving behavior.

In some embodiments, the autonomous control system comprises an advanced driver assistance system.

In some embodiments, the autonomous control unit comprises a determination component adapted to determine whether the associated driving data of the neighboring vehicle is suggestive of anomalous driving behavior.

In some embodiments, the determination component comprises a machine learning model trained to perceive anomalous driving behavior based on input data comprising the neighboring vehicle driving data.

In some embodiments, the determination component comprises a processor adapted to compare the associated driving data with threshold data, which when exceeded suggests that the neighboring vehicle is exhibiting anomalous driving behavior.

In some embodiments, the associated driving data comprises one or more movement patterns of the neighboring vehicle.

In some embodiments, the autonomous control unit is further adapted to selectively adjust default operation of the autonomous control system when the autonomous control system is already enabled.

In some embodiments, selective adjustment of the default operation of the autonomous control system comprises generating and offsetting parameters used to effectuate a resulting operation of the autonomous control system that counters exhibited anomalous driving behavior.

In accordance with another embodiment, a vehicle comprises an autonomous control system adapted to provide one or more commands to autonomously control one or more systems of the vehicle. The vehicle further comprises an autonomous control unit adapted to selectively adjust default operation of the autonomous control system in response to a determination regarding whether a neighboring vehicle, whose associated driving data influences the autonomous control system of the vehicle, is exhibiting anomalous driving behavior.

In some embodiments, the autonomous control system comprises an advanced driver assistance system.

In some embodiments, the autonomous control unit comprises a determination component adapted to determine whether the associated driving data of the neighboring vehicle is suggestive of anomalous driving behavior.

In some embodiments, the determination component comprises a machine learning model trained to perceive anomalous driving behavior based on input data comprising the neighboring vehicle driving data.

In some embodiments, the determination component comprises a processor adapted to compare the associated driving data with threshold data, which when exceeded suggests that the neighboring vehicle is exhibiting anomalous driving behavior.

In some embodiments, the associated driving data comprises one or more movement patterns of the neighboring vehicle.

In some embodiments, the selective adjustment of the default operation of the autonomous control system comprises offsetting parameters used to effectuate a resulting operation of the autonomous control system that counters exhibited anomalous driving behavior.

In accordance with another embodiment, a vehicle comprises: a processor; and a memory unit operatively connected to the processor and including computer code. The computer code, when executed, causes the processor to: monitor driving data associated with a neighboring vehicle proximate to the vehicle; determine whether the neighboring vehicle's driving data is indicative of anomalous driving behavior; determine whether an driver assistance system of the vehicle is enabled; and when the driver assistance system is not enabled, selectively enable the driver assistance system based on a determination regarding whether driving data associated with the neighboring vehicle is indicative of anomalous driving behavior; and when the driver assistance system is enabled, adjust operation of the driver assistance system based on the determination regarding whether driving data associated with the neighboring vehicle is indicative of anomalous driving behavior.

In some embodiments, the computer code causing the processor to determine whether the neighboring vehicle's driving data is indicative of anomalous driving behavior comprises a machine learning model trained to perceive anomalous driving behavior based on input data comprising the driving data associated with the neighboring vehicle.

In some embodiments, the computer code causing the processor to determine whether the neighboring vehicle's driving data is indicative of anomalous driving behavior further causes the processor to compare the associated driving data with threshold data, which when exceeded suggests that the neighboring vehicle is exhibiting anomalous driving behavior.

The figures are not exhaustive and do not limit the present disclosure to the precise form disclosed.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the technology disclosed herein may be implemented.

FIG. 2A illustrates an example autonomous control system.

FIG. 2B illustrates an example selective ADAS control unit aspect of the autonomous control system of FIG. 2A.

FIG. 3 illustrates an example scenario in which selective ADAS control may be used in accordance with various embodiments of the technology disclosed herein.

FIG. 4 illustrates an example scenario in which selective ADAS control may be used in accordance with various embodiments of the technology disclosed herein.

FIG. 5 illustrates an example scenario in which selective ADAS control may be used in accordance with various embodiments of the technology disclosed herein.

FIG. 6 is a flow chart illustrating operations that may be performed to effectuate driver behavior-aware ADAS in accordance with one embodiment of the technology disclosed herein.

FIG. 7 is an example computing component that may be used to implement various features of embodiments described in the present disclosure.

The figures are not exhaustive and do not limit the present disclosure to the precise form disclosed.

### DETAILED DESCRIPTION

As alluded to above, ADAS and autonomous driving control systems can be used in vehicles to at least, in part, control or manage vehicle operation to provide varying levels of automated control or assistance. It should be understood that embodiments of the disclosed technology contemplate that an ADAS can provide assistance to human drivers/operators, but can also provide assistance to artificial intelligence (AI) drivers/operators, or even remote drivers/operates (human or AI/electronic). Typically, ADAS (e.g., adaptive cruise control (ACC), cooperative cruise control (C-ACC), personalized-ACC, etc.) observes a vehicle's surroundings, and based on those surroundings, takes control of vehicle operation to effectuate stable speeds, safe following distances, e.g., to neighboring vehicles, such as a preceding vehicle. Sometimes, vehicle surroundings may include other vehicles, as well as the manner in which those other vehicles may be behaving. Human drivers, when following or observing the driving characteristics of another vehicle, such as when human drivers follow a preceding vehicle, tend to inherit that other vehicle's driving behavior(s) and pattern(s). Thus, if a neighboring vehicle(s) is exhibiting undesirable driving behavior(s) and pattern(s), other vehicles will tend to follow suit by also exhibiting the same/similar undesirable driving behavior(s) and pattern(s).

The above-described issue with inheriting undesirable driving behavior(s) and pattern(s) is only exacerbated in the case of ADAS. That is, when other nearby vehicles are behaving (e.g., are being operated) in an abnormal manner, those other nearby vehicles can influence ADAS operation of another vehicle. That is, the other vehicle's ADAS can imitate such behavior, and as a result, can potentially cause further abnormal/undesirable driving behaviors, or create further risk. ADAS imitation of undesirable driving behavior(s) may also cause discomfort to vehicle occupants. For example, vehicles being driven/controlled in an aggressive manner (cutting off other vehicles, driving well-above the speed limit, excessive weaving in/out/between traffic and lanes of traffic) can cause vehicle occupants to be “thrown” about a vehicle's cabin, cause loose objects in the vehicle's cabin to move about, cause the driver of the vehicle to become distracted, and so on. Some studies show that up to 70 percent of drivers experience uncomfortable situations when using/relying on ADAS, such as ACC. In those situations where drivers felt discomfort by virtue of the ADAS, drivers indicated they manually canceled/disabled the ADAS about 92 percent of the time. When a human driver imitates undesirable behavior, at least the comfort of that human driver is not as compromised since the human driver is choosing (him/herself) to imitate another vehicle's behavior.

Accordingly, examples of the disclosed technology are directed to observing/sensing driving data associated with neighboring vehicles, and using such driving data (indicative of or reflecting driving behaviors) as a basis for determining whether or not to activate an ADAS. In scenarios where ADAS is already active, e.g., a vehicle's ACC is in use, examples of the disclosed technology may be used to selectively adjust operation (when deemed appropriate) of the ADAS (e.g., adjust ADAS parameters according to which the ADAS operates to offset or compensate for imitated, undesirable driving behavior(s)). As used herein, the term selective/selectively can refer to operations that may or may not be taken depending on a given scenario, or otherwise, dynamic operation, where a particular action or set of actions is undertaken or performed based on some prerequisite or existing condition(s). However, such an action/set of actions need not necessarily be undertaken/performed all the time, only as warranted, necessary, or desired (i.e., selectively). For example, as will be described below, selective control of ADAS may amount to enabling ADAS in some scenarios, while preventing (or disabling) ADAS in other scenarios.

It should be understood that conventional ADAS typically focuses on target vehicle election according to travel settings, where operational profiles of a vehicle are modified with respect to/relative to neighboring vehicles. However, conventional ADAS fails to consider how driving behavior can change over time, and thus, is susceptible to driving behavior propagation. However, in some embodiments of the disclosed technology, the movement or actions of neighboring vehicles, e.g., a neighboring vehicle exhibiting erratic driving behavior(s) can be inferred or predicted. That is, embodiments of the disclosed technology are able to go beyond addressing singular or disparate instances of undesirable driving behavior(s), and can address undesired driving behavior(s) over some time period. It should be noted that attempting to address singular events or discrete aspects of undesired driving behavior (e.g., reacting to a hard braking event) can, in some instances contribute to the propagation of undesired driving behaviors. Therefore, and additionally, some embodiments are directed to implementing coordinated or cooperative ADAS operation between multiple neighboring vehicles. For example, upon determining that a first neighboring vehicle amongst a plurality of neighboring vehicles is exhibiting undesirable driving behavior(s), second and third vehicles (e.g., lag and ego vehicles) can coordinate ADAS operation between themselves as well between themselves and remaining vehicles of the plurality of neighboring vehicles through peer-to-peer networking, connected vehicle/infrastructure communications, etc.

In some examples, a vehicle's sensors that provide the driving data on which conventional ADAS operation is based may still be leveraged in accordance with various examples. Alternatively, or in addition to the use of the vehicle's sensors, interfaces that receive information regarding a vehicle's surroundings or operating environment, such as V2X receivers that receive information from service providers, roadway infrastructure, other vehicles, etc. may also provide driving data on which ADAS operation may be based.

However, instead of blindly using such driving data of neighboring vehicles to inform operation of the ADAS, examples of the disclosed technology analyze such driving data to determine whether or not the driving data indicates or reflects undesirable driving behavior(s) (including undesirable movement patterns or behaviors occurring over some period of time) of such neighboring vehicles. Comparisons can be made between a neighboring vehicle's driving behavior(s) as evidenced by operating conditions, e.g., vehicle speed, acceleration/deceleration, frequency of lane changes, amounts of yaw/roll/pitch exhibited by the neighboring vehicle, etc., and baseline or default operating conditions reflecting desirable or non-offensive driving behavior(s). In some embodiments, intelligent methods of ascertaining undesirable driving behavior can include the use of machine learning models (or similar mechanisms) to predict or perceive a neighboring vehicle's driving behavior(s) as being undesirable. Any method of determining whether or not observed driving/vehicle behavior is undesirable may be leveraged by embodiments of the disclosed technology. Thereafter, as noted above, upon a determination that the neighboring vehicle's driving behavior(s) is undesirable, the (ego) vehicle's ADAS can be adjusted accordingly, or the vehicle's ADAS may be disabled/prevented from being enabled. The systems and methods disclosed herein may be implemented with or by any type or kind or implementation of ADAS or other driver assistance system. Moreover, the systems and methods disclosed herein contemplate coordinated adjustment efforts across multiple ADAS implementations operable on multiple vehicles.

Additionally, the systems and methods disclosed herein may be implemented with a number of different vehicles and vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle is illustrated and described below as one example.

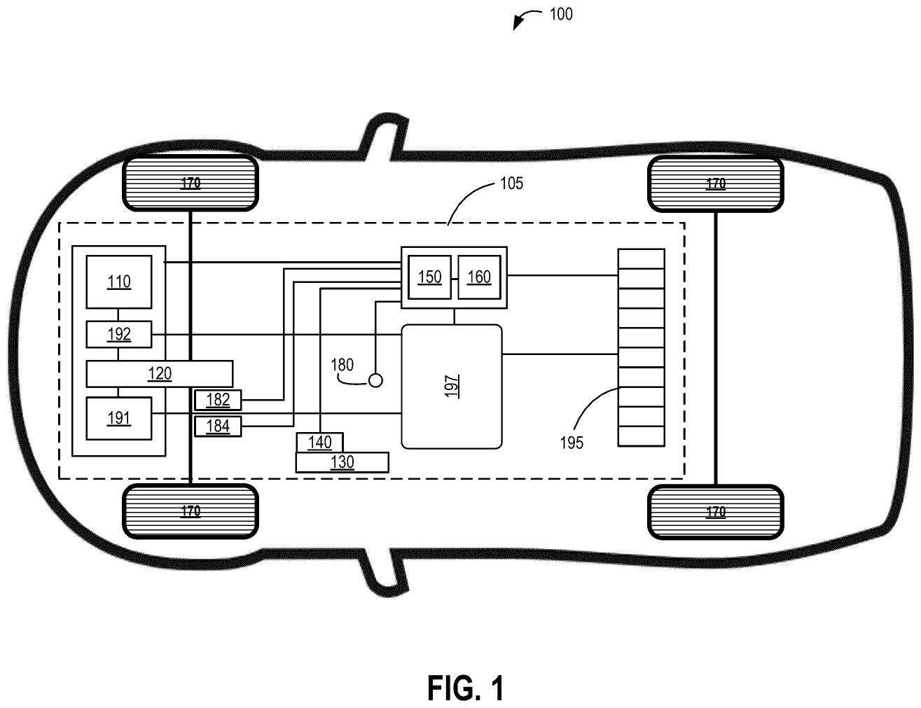

FIG. 1 illustrates an example vehicle 100, in this example, a hybrid electric vehicle (HEV), in which various embodiments for driver disengagement of autonomous vehicle/driving controls may be implemented. It should be understood that various embodiments disclosed herein may be applicable to/used in various vehicles (internal combustion engine (ICE) vehicles, fully electric vehicles (EVs), etc.) that are fully or partially autonomously controlled/operated, not only vehicles.

Vehicle 100 can include drive force unit 105 and wheels 170. Drive force unit 105 may include an engine 110, motor generators (MGs) 191 and 192, a battery 195, an inverter 197, a brake pedal 130, a brake pedal sensor 140, a transmission 120, a memory 160, an electronic control unit (ECU) 150, a shifter 180, a speed sensor 182, and an accelerometer 184.

Engine 110 primarily drives the wheels 170. Engine 110 can be an ICE that combusts fuel, such as gasoline, ethanol, diesel, biofuel, or other types of fuels which are suitable for combustion. The torque output by engine 110 is received by the transmission 120. MGs 191 and 192 can also output torque to the transmission 120. Engine 110 and MGs 191 and 192 may be coupled through a planetary gear (not shown in FIG. 1B). The transmission 120 delivers an applied torque to the wheels 170. The torque output by engine 110 does not directly translate into the applied torque to the wheels 170.

MGs 191 and 192 can serve as motors which output torque in a drive mode, and can serve as generators to recharge the battery 195 in a regeneration mode. The electric power delivered from or to MGs 191 and 192 passes through inverter 197 to battery 195. Brake pedal sensor 140 can detect pressure applied to brake pedal 130, which may further affect the applied torque to wheels 170. Speed sensor 182 is connected to an output shaft of transmission 120 to detect a speed input which is converted into a vehicle speed by ECU 150. Accelerometer 184 is connected to the body of vehicle 100 to detect the actual deceleration of vehicle 100, which corresponds to a deceleration torque.

Transmission 120 is a transmission suitable for an HEV. For example, transmission 120 can be an electronically controlled continuously variable transmission (ECVT), which is coupled to engine 110 as well as to MGs 191 and 192. Transmission 120 can deliver torque output from a combination of engine 110 and MGs 191 and 192. The ECU 150 controls the transmission 120, utilizing data stored in memory 160 to determine the applied torque delivered to the wheels 170. For example, ECU 150 may determine that at a certain vehicle speed, engine 110 should provide a fraction of the applied torque to the wheels while MG 191 provides most of the applied torque. ECU 150 and transmission 120 can control an engine speed (N_{E}) of engine 110 independently of the vehicle speed (V).

ECU 150 may include circuitry to control the above aspects of vehicle operation. ECU 150 may include, for example, a microcomputer that includes a one or more processing units (e.g., microprocessors), memory storage (e.g., RAM, ROM, etc.), and I/O devices. ECU 150 may execute instructions stored in memory to control one or more electrical systems or subsystems in the vehicle. ECU 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 191 and 192 each may be a permanent magnet type synchronous motor including for example, a rotor with a permanent magnet embedded therein. MGs 191 and 192 may each be driven by an inverter controlled by a control signal from ECU 150 so as to convert direct current (DC) power from battery 195 to alternating current (AC) power, and supply the AC power to MGs 191, 192. MG 192 may be driven by electric power generated by motor generator MG 191. It should be understood that in embodiments where MG 191 and MG 192 are DC motors, no inverter is required. The inverter, in conjunction with a converter assembly may also accept power from one or more of MGs 191, 192 (e.g., during engine charging), convert this power from AC back to DC, and use this power to charge battery 195 (hence the name, motor generator). ECU 150 may control the inverter, adjust driving current supplied to MG 192, and adjust the current received from MG 191 during regenerative coasting and braking.

Battery 195 may be implemented as one or more batteries or other power storage devices including, for example, lead-acid batteries, lithium ion, and nickel batteries, capacitive storage devices, and so on. Battery 195 may also be charged by one or more of MGs 191, 192, such as, for example, by regenerative braking or by coasting during which one or more of MGs 191, 192 operates as generator. Alternatively (or additionally, battery 195 can be charged by MG 191, for example, when vehicle 100 is in idle (not moving/not in drive). Further still, battery 195 may be charged by a battery charger (not shown) that receives energy from engine 110. The battery charger may be switched or otherwise controlled to engage/disengage it with battery 195. For example, an alternator or generator may be coupled directly or indirectly to a drive shaft of engine 110 to generate an electrical current as a result of the operation of engine 110. Still other embodiments contemplate the use of one or more additional motor generators to power the rear wheels of a vehicle (e.g., in vehicles equipped with 4-Wheel Drive), or using two rear motor generators, each powering a rear wheel.

Battery 195 may also be used to power other electrical or electronic systems in the vehicle. Battery 195 can include, for example, one or more batteries, capacitive storage units, or other storage reservoirs suitable for storing electrical energy that can be used to power MG 191 and/or MG 192. When battery 195 is implemented using one or more batteries, the batteries can include, for example, nickel metal hydride batteries, lithium ion batteries, lead acid batteries, nickel cadmium batteries, lithium ion polymer batteries, and other types of batteries.

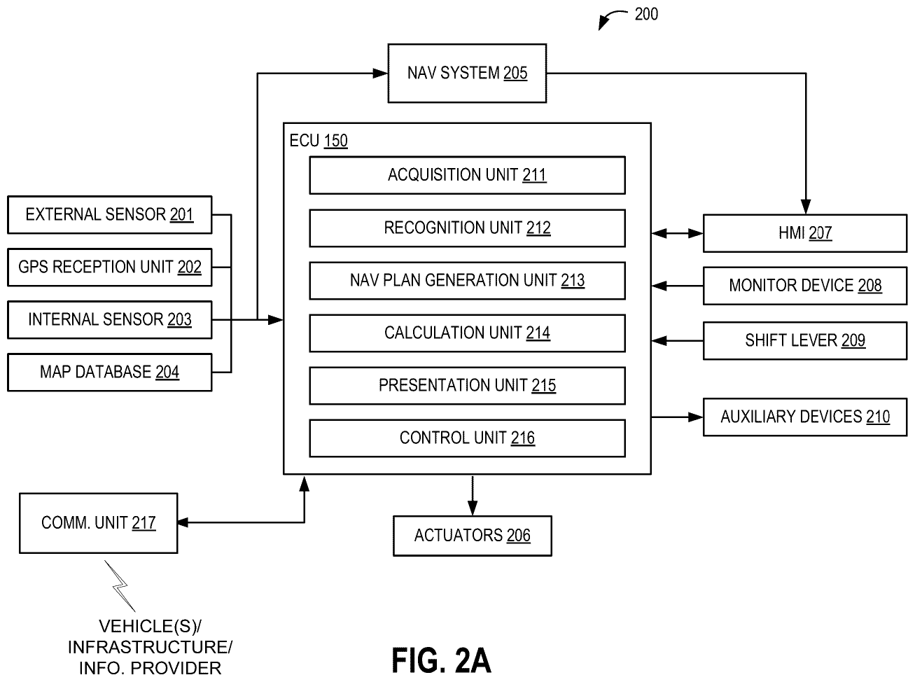

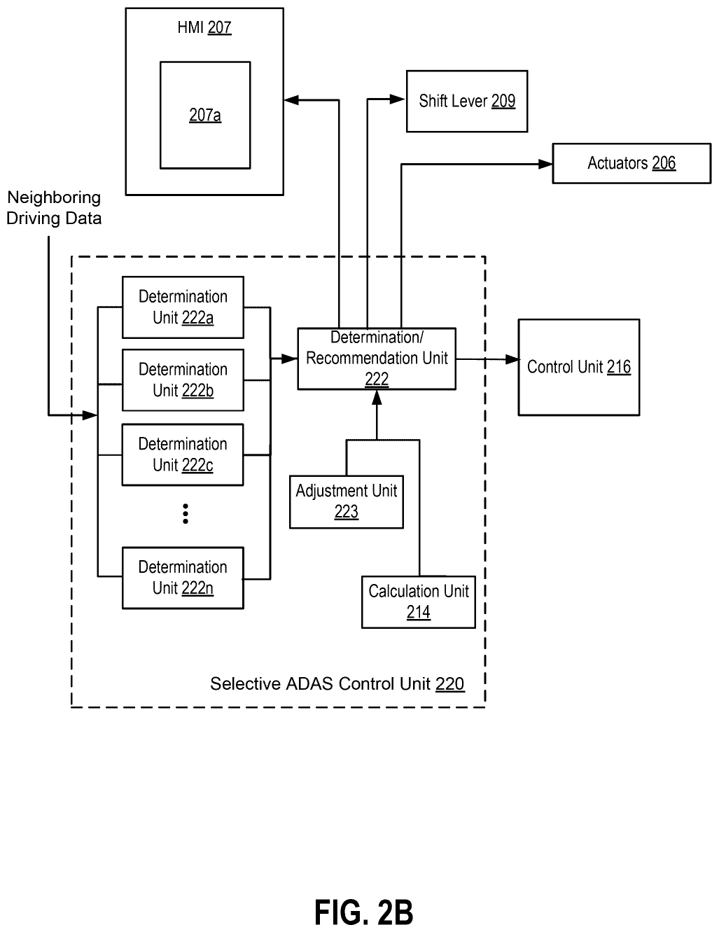

FIG. 2A illustrates an example autonomous control system 200 that may be used to autonomously control a vehicle, e.g., vehicle 100. Autonomous control system 200 may be installed in vehicle 100, and executes autonomous control of vehicle 100. As described herein, autonomous control can refer to control that executes driving/assistive driving operations such as acceleration, deceleration, and/or steering of a vehicle, general movement of the vehicle, without depending or relying on driving operations/directions by a driver or operator of the vehicle.

As an example, autonomous control may include a lane keeping assist control, one example of ADAS, where a steering wheel (not shown) is steered automatically (namely, without depending on a steering operation by the driver) such that vehicle 100 does not depart from a running lane. That is, the steering wheel is automatically operated/controlled such that vehicle 100 runs along the running lane, even when the driver does not perform any steering operation.

As another example, autonomous control may include navigation control in the context of ACC, where when there is no preceding vehicle in front of the vehicle 100, constant speed (cruise) control is effectuated to make vehicle 100 run at a predetermined constant speed. When there is a preceding vehicle in front of vehicle 100, follow-up control is effectuated to adjust vehicle 100's speed according to a distance between vehicle 100 and the preceding vehicle.

In some scenarios, switching from autonomous control to manual driving may be executed. Whether or not to execute this switch from autonomous control to manual driving may be determined based on a comparison between a comparison target and a threshold. In one embodiment, the comparison target is quantified so as to be compared with the threshold. When the comparison target is equal to or more than the threshold, the autonomous control system 200 executes the switch from an autonomous control mode to a manual driving mode. In other situations/scenarios, autonomous control system 200 may take over operation, effecting a switch from manual driving/control to autonomous control. As will be discussed in greater detail below, autonomous control system 200 may make certain determinations regarding whether to comply or proceed with autonomous control based on a command from autonomous control system 200, whether current operation of autonomous control system 200 should be adjusted, or whether to activate autonomous control at all. For example, when ADAS or some ADAS aspect of autonomous control system 200 is receiving driving data regarding one or more neighboring vehicles (e.g., from external sensor 201), embodiments of the disclosed technology determine whether the received driving data indicates that the one or more neighboring vehicles is exhibiting undesirable driving behavior(s). If so, autonomous control system 200 may be prohibited from controlling operation of vehicle 100, or if autonomous control system 200 is already active, operation of autonomous control system 200 may be adjusted so that vehicle 100 avoids imitating or limits the level of imitation of the one or more neighboring vehicle's driving behavior(s).

It should be understood that manual control or manual driving can refer to a vehicle operating status wherein a vehicle's operation is based mainly on driver-controlled operations/maneuvers. In an ADAS context, driving operation support control can be performed during manual driving. For example, a driver may be actively performing any of a steering operation, an acceleration operation, and a brake operation of the vehicle, while autonomous control apparatus 200 performs some subset of one or more of those operations, e.g., in an assistive, complementary, or corrective manner. As another example, driving operation support control adds or subtracts an operation amount to or from the operation amount of the manual driving (steering, acceleration, or deceleration) that is performed by the driver.

In the example shown in FIG. 2A, autonomous control system 200 is provided with an external sensor 201, a GPS (Global Positioning System) reception unit 202, an internal sensor 203, a map database 204, a navigation system 205, actuators 206, an HMI (Human Machine Interface) 207, a monitor device 208, a shift lever 209, auxiliary devices 210. Autonomous control system 200 may communicate with ECU 150, or in some embodiments (may be implemented with its own ECU).

In the example shown in FIG. 2A, external sensor 201 is a detector that detects external circumstances such as surrounding information of vehicle 100. The external sensor 201 may include at least one of a camera, a radar, and a Laser Imaging Detection and Ranging (LIDAR) unit.

The camera unit may be an imaging device that images the external circumstances surrounding the vehicle. For example, the camera is provided on a back side of a front windshield of the vehicle. The camera may be a monocular camera or a stereo camera. The camera outputs, to the ECU 150, image information on the external circumstances surrounding the vehicle. The camera is not limited to a visible light wavelength camera but can be an infrared camera.

The radar unit uses radio waves to detect obstacles outside of the vehicle by transmitting radio waves to the surroundings of the vehicle, and receiving reflected radio waves from an obstacle to detect the obstacle, distance to the obstacle or a relative positional direction of the obstacle. The radar unit outputs detected obstacle information to the ECU 150.

The LIDAR unit may operate similar to the manner in which the radar unit operates except that light is used in place of radio waves. The LIDAR unit outputs detected obstacle information to the ECU 150.

In the example shown in FIG. 2A, GPS reception unit 202 receives signals from three or more GPS satellites to obtain position information indicating a position of vehicle 100. For example, the position information can include latitude information and longitude information. The GPS reception unit 202 outputs the measured position information of the vehicle to the ECU 150.

In the example shown in FIG. 2A, the internal sensor 203 is a detector for detecting information regarding, e.g., a running status of vehicle 100, operational/operating conditions, e.g., amount of steering wheel actuation, rotation, angle, amount of acceleration, accelerator pedal depression, brake operation by the driver of vehicle 100. The internal sensor 203 includes at least one of a vehicle speed sensor, an acceleration sensor, and a yaw rate sensor. Moreover, internal sensor 203 may include at least one of a steering sensor, an accelerator pedal sensor, and a brake pedal sensor.

A vehicle speed sensor is a detector that detects a speed of the vehicle 100. In some embodiments, vehicle 100's speed may be measured directly or through calculations/inference depending on the operating conditions/status of one or more other components of vehicle 100. For example, a wheel speed sensor can be used as the vehicle speed sensor to detect a rotational speed of the wheel, which can be outputted to ECU 150.

The acceleration sensor can be a detector that detects an acceleration of the vehicle. For example, the acceleration sensor may include a longitudinal acceleration sensor for detecting a longitudinal acceleration of vehicle 100, and a lateral acceleration sensor for detecting a lateral acceleration of vehicle 100. The acceleration sensor outputs, to the ECU 150, acceleration information.

The yaw rate sensor can be a detector that detects a yaw rate (rotation angular velocity) around a vertical axis passing through the center of gravity of vehicle 100. For example, a gyroscopic sensor is used as the yaw rate sensor. The yaw rate sensor outputs, to the ECU 150, yaw rate information including the yaw rate of vehicle 100.

The steering sensor may be a detector that detects an amount of a steering operation/actuation with respect to a steering wheel 30 by the driver of vehicle 100. The steering operation amount detected by the steering sensor may be a steering angle of the steering wheel or a steering torque applied to the steering wheel, for example. The steering sensor outputs, to the ECU 150, information including the steering angle of the steering wheel or the steering torque applied to the steering wheel of vehicle 100.

The accelerator pedal sensor may be a detector that detects a stroke amount of an accelerator pedal, for example, a pedal position of the accelerator pedal with respect to a reference position. The reference position may be a fixed position or a variable position depending on a determined parameter. The accelerator pedal sensor is provided to a shaft portion of the accelerator pedal AP of the vehicle, for example. The accelerator pedal sensor outputs, to the ECU 150, operation information reflecting the stroke amount of the accelerator pedal.

The brake pedal sensor may be a detector that detects a stroke amount of a brake pedal, for example, a pedal position of the brake pedal with respect to a reference position. Like the accelerator position, a brake pedal reference position may be a fixed position or a variable position depending on a determined parameter. The brake pedal sensor may detect an operation force of the brake pedal (e.g. force on the brake pedal, oil pressure of a master cylinder, and so on). The brake pedal sensor outputs, to the ECU 150, operation information reflecting the stroke amount or the operation force of the brake pedal.

A map database 204 may be a database including map information. The map database 204 is implemented, for example, in a disk drive or other memory installed in vehicle 100. The map information may include road position information, road shape information, intersection position information, and fork position information, for example. The road shape information may include information regarding a road type such as a curve and a straight line, and a curvature angle of the curve. When autonomous control system 200 uses a Simultaneous Localization and Mapping (SLAM) technology or position information of blocking structural objects such as buildings and walls, the map information may further include an output signal from external sensor 201. In some embodiments, map database 204 may be a remote data base or repository with which vehicle 100 communicates.

Navigation system 205 may be a component or series of interoperating components that guides the driver of vehicle 100 to a destination on a map designated by the driver of vehicle 100. For example, navigation system 205 may calculate a route followed or to be followed by vehicle 100, based on the position information of vehicle 100 measured by GPS reception unit 202 and map information of map database 204. The route may indicate a running lane of a section(s) of roadway in which vehicle 100 traverses, for example. Navigation system 205 calculates a target route from the current position of vehicle 100 to the destination, and notifies the driver of the target route through a display, e.g., a display of a head unit, HMI 207 (described below), and/or via audio through a speaker(s) for example. The navigation system 205 outputs, to the ECU 150, information of the target route for vehicle 100. In some embodiments, navigation system 205 may use information stored in a remote database, like map database 204, and/or some information processing center with which vehicle 100 can communicate. A part of the processing executed by the navigation system 205 may be executed remotely as well.

Actuators 206 may be devices that execute running controls of vehicle 100. The actuators 206 may include, for example, a throttle actuator, a brake actuator, and a steering actuator. For example, the throttle actuator controls, in accordance with a control signal output from the ECU 150, an amount by which to open the throttle of vehicle 100 to control a driving force (the engine) of vehicle 100. In another example, actuators 206 may include one or more of MGs 191 and 192, where a control signal is supplied from the ECU 150 to MGs 191 and/or 192 to output motive force/energy. The brake actuator controls, in accordance with a control signal output from the ECU 150, the amount of braking force to be applied to each wheel of the vehicle, for example, by a hydraulic brake system. The steering actuator controls, in accordance with a control signal output from the ECU 150, driving an assist motor of an electric power steering system that controls steering torque.

HMI 207 may be an interface used for communicating information between a passenger(s) (including the operator) of vehicle 100 and autonomous control system 200. For example, the HMI 207 may include a display panel for displaying image information for the passenger(s), a speaker for outputting audio information, and operation buttons or a touch panel used by the occupant for performing an input operation. HMI 207 may also or alternatively transmit the information to the passenger(s) through a mobile information terminal connected wirelessly and receive the input operation by the passenger(s) through the mobile information terminal.

Monitor device 208 monitors a status of the driver/operator. The monitor device 208 can check a manual driving preparation state of the driver. More specifically, the monitor device 208 can check, for example, whether or not the driver is ready to start manual operation of vehicle 100. Moreover, the monitor device 208 can check, for example, whether or not the driver has some intention of switching vehicle 100 to a manual mode of operation.

For example, the monitor device 208 may be a camera that can take an image of the driver, where the image can be used for estimating the degree to which the driver's eyes are open, the direction of the driver's gaze, whether or not the driver is holding the steering wheel, etc. Monitor device 208 may also be a pressure sensor for detecting the amount of pressure the driver's hand(s) are applying to the steering wheel. As another example, the monitor device 208 can be a camera that takes an image of a hand of the driver.

A shift lever 209 can be positioned at a shift position, e.g., “A (AUTOMATIC),” “D (DRIVE),” etc. The shift position “A” indicates, for example, an automatic engage mode where autonomous control is engaged automatically. The shift position “D” indicates a triggered engage mode where autonomous control is engaged in response to a driver-initiated request to operate vehicle 100 in an autonomous driving mode.

Auxiliary devices 210 may include devices that can be operated by the driver of the vehicle, but are not necessarily drive-related, such as actuators 206. For example, auxiliary devices 210 may include a direction indicator, a headlight, a windshield wiper and the like.

ECU 150 may execute autonomous control of the vehicle, and may include an acquisition unit 211, a recognition unit 212, a navigation plan generation unit 213, a calculation unit 214, a presentation unit 215, and a control unit 216.

Acquisition unit 211 may obtain the following operation amounts or levels of actuation based on the information obtained by the internal sensor 203: steering operation, acceleration operation, and brake operation by the driver during an autonomous control mode; and the level of steering operation, acceleration operation, and brake operation by the driver of the vehicle during a manual control mode.

Recognition unit 212 may recognize or assess the environment surrounding or neighboring vehicle 100 based on the information obtained by the external sensor 201, the GPS reception unit 202, and/or the map database 204. For example, the recognition unit 212 includes an obstacle recognition unit (not shown), a road width recognition unit (not shown), and a facility recognition unit (not shown). The obstacle recognition unit recognizes, based on the information obtained by the external sensor 201, obstacles surrounding the vehicle. For example, the obstacles recognized by the obstacle recognition unit include moving objects such as pedestrians, other vehicles, motorcycles, and bicycles and stationary objects such as a road lane boundary (white line, yellow line), a curb, a guard rail, poles, a median strip, buildings and trees. The obstacle recognition unit obtains information regarding a distance between the obstacle and the vehicle, a position of the obstacle, a direction, a relative velocity, a relative acceleration of the obstacle with respect to the vehicle, and a category and attribution of the obstacle. The category of the obstacle includes a pedestrian, another vehicle, a moving object, and a stationary object. The attribution of the obstacle can refer to a property of the obstacle such as hardness and a shape of the obstacle.

The road width recognition unit recognizes, based on the information obtained by the external sensor 201, the GPS reception unit 202, and/or the map database 204, a road width of a road in which the vehicle is running.

The facility recognition unit recognizes, based on the map information obtained from the map database 204 and/or the vehicle position information obtained by the GPS reception unit 202, whether or not vehicle 100 is operating/being driven through an intersection, in a parking structure, etc. The facility recognition unit may recognize, based on the map information and the vehicle position information, whether or not the vehicle is running in a school zone, near a childcare facility, near a school, or near a park, etc.

Navigation plan generation unit 213 may generate a navigation plan for vehicle 100 based on the target route calculated by the navigation system 205, the information on obstacles surrounding vehicle 100 recognized by recognition unit 212, and/or the map information obtained from map database 204. The navigation plan may be reflect one or more operating conditions/controls to effectuate the target route. For example, the navigation plan can include a target speed, a target acceleration, a target deceleration, a target direction, and/or a target steering angle with which vehicle 100 should be operated at any point(s) along the target route so that the target route can be achieved to reach a desired destination. It should be understood that navigation plan generation unit 213 generates the navigation plan such that vehicle 100 operates along the target route while satisfying one or more criteria and/or constraints, including, for example, safety constraints, legal compliance rules, operating (fuel/energy) efficiency, and the like. Moreover, based on the existence of obstacles surrounding vehicle 100, the navigation plan generation unit 213 generates the navigation plan for the vehicle so as to avoid contact with such obstacles.

Calculation unit 214 may calculate a threshold used for determining whether or not to switch from autonomous control to manual driving or vice versa. The determination can be performed based on the operating levels associated with the manner in which the driver is operating vehicle 100 during autonomous control which is obtained by the acquisition unit 211. For example, the driver of vehicle 100 may suddenly grasp the steering wheel (which can be sensed by internal sensor 203) and stomp on the brake pedal (which can be sensed by monitor device 208). The pressure on the steering wheel and the level of actuation of the brake pedal may be excessive enough (exceed a threshold) suggesting that the driver intends to override the autonomous control system 200.

Presentation unit 215 displays, on a display of the HMI 207, a threshold which is calculated by the calculation unit 214 and used for determining whether or not to execute the switching from autonomous control to the manual driving or vice versa.

Control unit 216 can autonomously control vehicle 100 based on the navigation plan generated by navigation plan generation unit 213. The control unit 216 outputs, to the actuators 206, control signals according to the navigation plan. That is, the control unit 216 controls actuators 206 based on the navigation plan, and thereby autonomous control of vehicle 100 is executed/achieved. Moreover, certain levels of operation, e.g., steering wheel actuation, by the driver can be detected by the acquisition unit 211. When such level(s) equal or exceed the threshold calculated by the calculation unit 214 in a period during which autonomous control is being used to operate vehicle 100, control unit 216 executes a switching from autonomous control to manual control.

Control unit 216 may be an embodiment of an ADAS, e.g., control unit 216 may comprise a ADAS that encompasses all ADAS features/functions, e.g., lane keeping assist, ACC, and so on. In some embodiments, control unit 216 may represent a plurality of ADAS components or functions, each implementing/comprising a particular type of a ADAS functionality. It should be understood that ADAS is known in the art, and the manner in which ADAS may be implemented can vary in accordance with different embodiments of the disclosed technology. One example description of an ADAS, which is incorporated herein by reference, is U.S. patent Ser. No. 10/202,127.

A communications unit 217 may comprise a wireless transceiver circuit (that can include a transmitter/receiver) with an associated antenna to allow wireless communications via any of a number of communication protocols such as, for example, WiFi, Bluetooth, near field communications (NFC), Zigbee, cellular, dedicated short range communications (DSRC), and any of a number of other wireless communication protocols whether standardized, proprietary, open, point-to-point, networked or otherwise.

Referring to FIG. 2B, control unit 216 operatively interacts with selective ADAS control unit 220 that determines whether or not autonomous control system 200 (in particular, control unit 216) can engage in autonomous control of vehicle 100. For example, selective ADAS control unit 220 may include one or more determination units, e.g., determination unit 222a determines whether or not autonomous control can be engaged, based on a difference between a vehicle position calculated from signals received by the GPS reception unit 202 and an actual vehicle position calculated based on an output signal from the external sensor 201, the map information of the map database 204 and so forth. For example, a threshold condition associated with engagement of autonomous control in vehicle 100 may be predicated on travel along a certain type of roadway, e.g., known segment(s) of road within map database 204, such as a freeway (versus) country lane. Road curvature may be another condition/characteristic on which autonomous control of vehicle 100 may be based. Determination unit 222a may make its determination based on one or more determinative factors.

Control unit 216 may further interact with a determination unit 222b of selective ADAS control unit 220 that determines whether or not a trigger to deactivate (stop) an autonomous control mode exists. For example, determination unit 222b can determine whether or not to execute the switch from the autonomous control to manual control based on the level of steering wheel actuation, brake pedal actuation, etc. effectuated by the driver while vehicle 100 is being operated in an autonomous control mode, which is obtained by the acquisition unit 211. Other determinative factors or considerations may be the amount of acceleration or deceleration experienced by vehicle 100, also determined by acquisition unit 211.

Control unit 216 may further interact with a determination unit 222c of selective ADAS control unit 220 that determines whether or not a neighboring vehicle on which ADAS operation of vehicle 100 may be based, at least in part, is exhibiting undesirable driving behavior(s). Determination unit 222c may, as noted above, be embodied as a machine learning component(s) configured to determine whether or not observed driving behavior(s) of a neighboring vehicle is undesirable or otherwise abnormal. In some embodiments, a particular machine learning model/engine may be implemented for each type or category of ADAS. As noted above, there are different types of ADAS, e.g., personalized ACC, cooperative ACC, lane keeping assist, and so on. Thus, a mechanism embodied by determination units, e.g., determination unit 222c to determination unit 222n, may be implemented to determine whether or not the driving behavior(s) associated with a neighboring vehicle is undesirable in each particular ADAS context. In other embodiments, a single or some other number of determination units may be used to determine whether or not neighboring vehicles' driving behavior(s) is undesirable.

It should be understood that determining undesirable driving behavior may comprise characterizing one or more aspects or elements of a neighboring vehicle's operation, including repeated movement patterns. For example, determination unit 222c may comprise a machine learning model that can take as input, vehicle speed, along with rates of acceleration and deceleration, as well, e.g., the number of acceleration/deceleration events or instances that occur during a given measuring period. Other example inputs can include, as alluded to above, repetitive movement patterns, such as continued or multiple instances of weaving in traffic (that can be a combination of multiple lane changes or directional movements suggesting repetitive zig-zagging or driving in an “S” pattern at high speed over time). Such information can be received by determination unit 222c from, e.g., recognition unit 212 by way of external sensors 201, and determination unit 222c can perceive or determine that the driving behavior(s) of the vehicle being monitored or observed is undesirable. In some embodiments, determining undesirable driving behavior may comprise comparing operational characteristics of a neighboring vehicle with known (or calculated, e.g., by calculation unit 214) thresholds associated with driving behavior (e.g., traveling 5 mph above the speed limit may not warrant adjustment or eschewing use of ADAS, whereas traveling 30 mph above the speed limit may trigger an adjustment to or recommendation to avoid ADAS.

It should be noted that awareness of nearby driving behavior(s) can be instrumental in pro-active accident prevention. Again, driving behaviors tend to be propagated to nearby vehicles, e.g., if a preceding vehicle is traveling abnormally slowly, and starts/stops frequently, a following vehicle tends to imitate the driving behaviors/follow suit. Another following vehicle preceded by the previous following vehicle may also imitate such driving behaviors. This results in the propagation of driving behavior, including undesired driving behavior.

In some embodiments, selective ADAS control unit 220 may further comprise an adjustment unit 223. As noted above, in some embodiments, the manner in which ADAS reacts to neighboring vehicles' driving behavior(s) can be tempered or adjusted in the event undesirable driving behavior(s) are being sensed from neighboring vehicles. That is, adjustment unit 223 may provide a mechanism to offset a default or “original” ADAS mode of operation when neighboring vehicles are exhibiting undesirable driving behavior(s). In this way, the risk(s) or issue(s) associated with imitating the driving behavior(s) of neighboring vehicles that may be exhibiting undesirable actions can be mitigated or eliminated altogether.

In some embodiments, adjustment unit 223 calculates parameter values or parameter value offsets that adjust some aspect(s) of operation determined by one or more determination units (described in greater detail below). For example, a default ADAS operation may comprise an ACC function that controls vehicle 100 by directing or providing instructions that when executed by control unit 216, causes vehicle 100 to follow a preceding vehicle by some given distance behind the preceding vehicle. However, if the preceding vehicle is traveling above a given threshold speed (e.g., some given speed above the speed limit), adjustment unit 223 determines the speed by which ADAS-recommended speed of travel for vehicle 100 should be reduced so that vehicle 100 remains at/below a posted speed limit. In this way, conventional operation of ADAS may be adjusted. As a result, unlawful/potentially dangerous operation due to excessive vehicle speed of vehicle 100 (by virtue of ADAS imitating the driving behavior(s) of neighboring vehicles) can be avoided.

When determination/recommendation unit 222 determines that the autonomous control can be engaged, based on the determinations performed by determination units 222a, 222b, and/or 222c, control unit 216 engages autonomous control of vehicle 100. That is, determination unit 222 may act as a determination aggregator that aggregates determinations rendered by other determination units. Determination unit 222 may be a circuit, e.g., application-specific integrated circuit, logic, software, or some combination thereof that processes the individual determinations rendered by the other determination units (e.g., determination units 222a, 222b, and 222c) to render an overall determination. That overall determination may control operation of control unit 216, e.g., to disengage autonomous control, and switch to manual control or engage in autonomous control, or in some instances, prevent engagement of autonomous control, and remain in a manual control mode.

It should be noted that embodiments of the disclosed technology contemplate that determinations regarding certain aspects of ADAS may influence or impact another aspect(s) of ADAS. For example, and as noted above, a threshold condition associated with engagement of autonomous control in vehicle 100 may be predicated on travel along a certain type of roadway, e.g., known segment(s) of road within map database 204, such as a freeway (versus) country lane. Thus, determination unit 222a may determine that operation of a vehicle under autonomous control is warranted given the vehicle is traveling a currently unpopulated (traffic-less), country road. This determination by determination unit 222a may be used in conjunction with a determination made by determination unit 222c that the monitored vehicle does not amount to or rise to the level of undesirable driving behavior, despite the monitored vehicle traveling above the speed limit. This is because, selective ADAS control unit 220, as a whole, can determine whether or not driving behavior(s) of neighboring vehicles is undesirable in particular contexts or environments.

Control unit 216 may then effectuate whatever actuations/operating levels/instructions, and so on provided by selective ADAS control unit 220. In the event vehicle 100's ADAS is already operational, control unit 216, based on determination/recommendation unit 222, may allow ADAS to continue to control/influence operation of vehicle 100, or if ADAS should be disabled or disengaged. In the event vehicle 100's ADAS is not engaged, control unit 216, based on determination/recommendation unit 222, may prevent ADAS from being enabled or engaged, or it may allow ADAS to control or influence operation of vehicle 100.

When determination units 222a, 222b, and/or 222c determine that a switch from autonomous control to the manual control should be executed, autonomous control is deactivated/disengaged by control unit 216 or control unit 216 is itself deactivated/disengaged, and the driver proceeds to manually control vehicle 100. It should be understood that other determination units may be used (or only a single determination unit may be used). In the case of multiple determination units being used, in some embodiments, any single determination that manual control should be executed can serve as a trigger to deactivate autonomous control. In some embodiments, presentation unit 215 is provided with a control state notification unit 215a that notifies the driver of a fact that vehicle 100 is operating under autonomous control is in execution, and so forth. Such a notification may be displayed on a display of HMI 207, for example. Likewise, If a switch from autonomous control to the manual control is executed, the control state notification unit 215a displays, on the display of HMI 207 a corresponding notification.

HMI 207, in some embodiments, may include an autonomous control engagement trigger input unit 207a that can be actuated by the driver of vehicle 100 to engage in an autonomous control mode (after safety control unit 220 determines that autonomous control can be effectuated).

In some embodiments, the driver of vehicle 100 may be able to select an automatic autonomous control engage mode, where autonomous control unit 216 can be automatically engaged when selective ADAS control unit 220 determines that the autonomous control can be engaged. In some embodiments, shift lever 209 may be used to set a triggered autonomous control mode and an automatic engage mode (as alluded to above by actuating shift lever 209 to an “A” (AUTOMATIC) position or to a “D” (DRIVE) position.

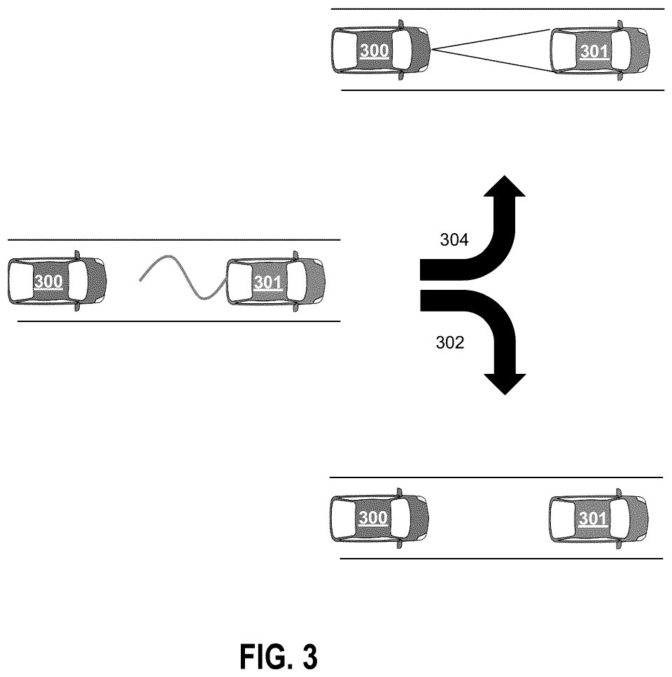

FIG. 3 illustrates an example scenario for which embodiments of the disclosed technology may be used. FIG. 3 illustrates an ego vehicle 300, which may be an embodiment of vehicle 100 (FIG. 1) following a preceding vehicle 301. As discussed above, the driving behavior(s) of a neighboring vehicle, in this example, preceding vehicle 301, may be observed or monitored. In other words, driving data or data characterizing operation of preceding vehicle 301 may be obtained by ego vehicle 300 using external sensors, via receipt of information from a service provider, etc.

The driving data is obtained so that the driving behavior(s) of preceding vehicle 301 can be characterized as being undesirable or abnormal, or as standard/normal (e.g., within certain operating thresholds or constraints). It should be understood that analysis of the driving behavior(s) of preceding vehicle 301 typically occurs in real-time or near real-time. This is because the aforementioned determination units 222 (and 222a-222n) (FIG. 2B) analyze driving data to determine at that time, whether or not ADAS should be enabled or adjusted.

If ADAS is not yet active or enabled in ego vehicle 300, at 302, the enablement of ADAS in ego vehicle 300 is prohibited. For example, ego vehicle 300, vis-h-vis ego vehicle 300's selective ADAS control unit 220, may determine that preceding vehicle 301 is exhibiting undesirable driving behavior(s) such as preceding vehicle 301 traveling beyond a threshold speed (e.g., above some given speed, such as a posted speed limit, or percentage relative to the posted speed limit, etc.). Accordingly, ego vehicle 300 will not be able to operate under ADAS, e.g., determination/recommendation unit 222 instructs control unit 216 to prohibit or prevent ADAS from being enabled by the driver/operator of ego vehicle 300. In some embodiments, the monitoring of neighboring vehicles, such as preceding vehicle 301, may be constant or otherwise performed in a way such that ADAS enablement/disablement determinations can be periodically made. If at some time, preceding vehicle 301 is observed to no longer be exhibiting undesirable driving behavior(s), a determination may be made at that time to allow engagement of ADAS. In other embodiments, the prohibition on enabling or engaging ADAS is time-based, e.g., after some defined amount of time has passed (relative to, e.g., when the determination is made to prohibit ADAS enablement), a driver of ego vehicle 300 may be allowed to engage ADAS pending subsequent observation of and determinations made regarding neighboring vehicles' driving behavior(s).

In other scenarios, such as at 304, ADAS may already have been enabled when ego vehicle 300 observes preceding vehicle 301. If ego vehicle 300 determines (by way of selective ADAS control unit 220) that preceding vehicle 301 is driving in an undesirable manner, adjustment unit 223 may determine adjustments to make to certain operating parameters of ego vehicle so that control unit 216 will not imitate undesirable driving behavior(s) of preceding vehicle 301. Following the above example, ego vehicle 300 may have ACC enabled while following preceding vehicle 301. Preceding vehicle may be speeding such that selective ADAS control unit 220 determines that ACC operation in ego vehicle 300 should be adjusted or adapted so as not to imitate the speeding of preceding vehicle 301. For example, recognition unit 212 (FIG. 2A) may determine an applicable speed limit of the roadway being traversed by ego vehicle 300 and preceding vehicle 301. ACC, in its default operation, may control ego vehicle 300 such that ego vehicle 300 remains 1 car length behind any preceding vehicle.

In this scenario, upon determining that preceding vehicle is exhibiting abnormal or undesirable driving behavior, i.e., driving too fast, adjustment unit 220 will adjust the default application/operation of ACC by compensating for the undesirable driving behavior. In this case, adjustment unit 220 may adjust operation of ACC by instructing control unit 216 to operate vehicle 300 such that it follows preceding vehicle 301 by at least two car lengths instead of one car length. For example, an operational parameter according to which ACC operates is offset, in this case, by a particular distance value representative of an additional distance ego vehicle 300 should stay away from preceding vehicle 301. Additionally, adjustment unit 220 may further adjust operation of ACC by instructing control unit 216 to operate vehicle 300 at a speed no more than the posted speed limit. For example, per default ACC operation, one of determination units, e.g., determination unit 222a determines that ego vehicle 300 should maintain a single car length distance from preceding vehicle 301. Another determination unit, e.g., determination unit 222c may determine that preceding vehicle is exhibiting undesired driving behavior by traveling too fast. Accordingly, determination/recommendation unit 222 may ultimately determine and recommend/instruct control unit 216 to add an additional car length's distance to any distance recommendation according to ACC provided by, e.g., determination unit 222a. Moreover, determination/recommendation unit 222 may further determine and recommend/instruct control unit 216 to offset (in this case, reduce) the speed at which ego vehicle 300 is to operate. That is, control unit 216 will instruct, e.g., ICE 110 or MG1/MG2 191/192 to operate/provide motive power at a reduced level to meet the adjusted speed at which ego vehicle 300 is to operate. Either one or both of these adjustments will help prevent the extension or extrapolation of undesired driving behavior(s) by an ego vehicle imitating driving behavior(s) of other neighboring vehicles. It should be noted that selective ADAS control unit 220 may adjust or implement any driving behaviors determined to alleviate or avoid driving behavior propagation. Accordingly, in the current scenario, selective ADS control unit 220 may compensate for undesirable driving behavior(s) of preceding vehicle 301 by further recommending via determination/recommendation unit 222, that ego vehicle 300 change lanes to avoid preceding vehicle 301 continuing to act as a basis for driving behavior(s) imitation and propagation.

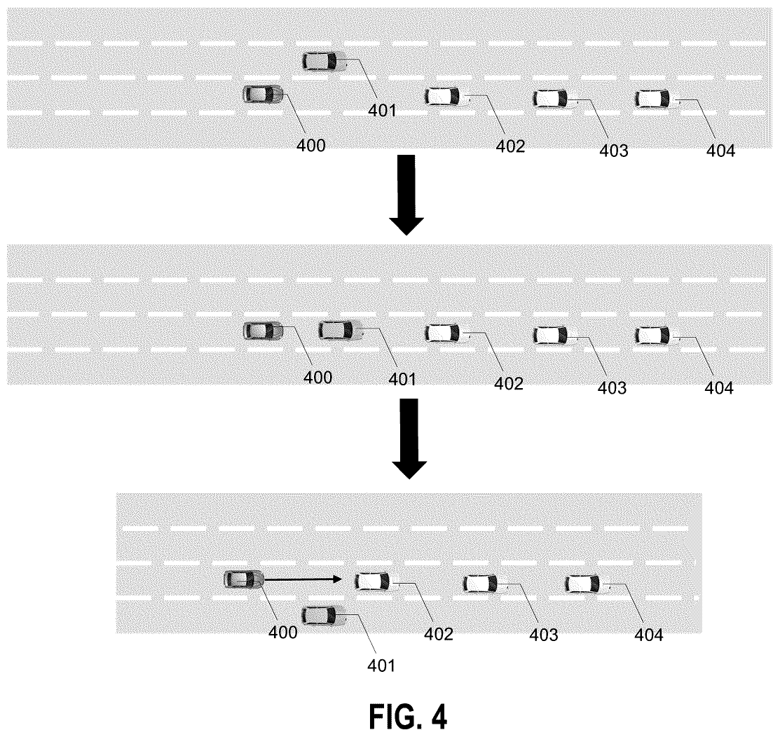

FIG. 4 illustrates another example scenario during which awareness of neighboring vehicle driving behavior(s) can be leveraged to avoid undesirable driving behavior(s), and ultimately, prevent accidents. In this example, ego vehicle 400 may be traveling in a first lane. Currently preceding ego vehicle 400 may be a first vehicle that can be monitored, e.g., by ego vehicle 400's external sensors. This first vehicle can be referred to as an ADAS (in this case, ACC) leader vehicle 402. Beyond ACC leader vehicle 402 are preceding vehicles 403 and 404. As preceding vehicles 403 and 404 are not “directly” or “immediately” preceding ego vehicle 400, preceding vehicles 403/404 may be ignored. In other embodiments/implementations, multiple neighboring/preceding vehicles may be monitored, and may impact ADAS operation of ego vehicle 400, depending on how a particular ADAS is configured to operate. In a second lane, next to the lane in which ego vehicle 400 is currently traveling, a neighboring vehicle 402 may be exhibiting aggressive driving maneuvers, e.g., traveling above the posted speed limit, weaving in/out of traffic or lanes, and so on. It should be understood that neighboring as used in the present disclosure can mean nearby or proximate, and is not necessarily limited or defined by a direction of proximity. Although the terms preceding and neighboring are used to describe the illustrated example, the distinction in this example is merely to avoid confusion. That is, vehicle 402 and 401 are both neighboring vehicles.

The above-described scenario may be represented mathematically as follows. The speed/velocity of ego vehicle 400 is less than a reference speed/velocity (e.g., posted speed limit), e.g., v_{ego}<v_{ref}. Meanwhile, the speed/velocity of neighboring vehicle 402 is greater than that of ego vehicle 400, e.g., v_{anamoly}>>v_{ego}. Following the example of FIG. 4, as illustrated, neighboring vehicle 401, recalling it is observed as exhibiting anomalous/undesirable behavior(s), e.g., speed and weaving in/out of lanes. Accordingly, neighboring vehicle 401 may, at some point, move into the same lane that ego vehicle 400 is traveling, ahead of ego vehicle 400. As a result, neighboring vehicle 401 now becomes a preceding vehicle relative to ego vehicle 400. In accordance with conventional ADAS operation, ego vehicle 400 would imitate the driving behavior(s) of neighboring vehicle 400 as it is now preceding ego vehicle 400. Recalling that neighboring vehicle 401 was (and may still be) traveling faster than ego vehicle 400. Accordingly, upon monitoring driving data of neighboring vehicle 401, ego vehicle 400, without the benefit of the disclosed technology would increase its speed and continue to follow neighboring vehicle 401.

At some point, neighboring vehicle 401 may leave its current lane of travel. In the illustrated example, neighboring vehicle 401, by virtue of switching lanes again, no longer is a preceding vehicle relative to ego vehicle 400. Instead, the original preceding vehicle/ADAS leader vehicle 402 again becomes a preceding vehicle. However, recall that ego vehicle 400 increased its speed (as a result of conventionally comparing operation profiles (e.g., speed/acceleration/deceleration) of ego vehicle 400 with that of neighboring vehicle 401, and altering the operation profile of ego vehicle 400 to match that of neighboring vehicle 401). As a result of neighboring vehicle 401 switching lanes, and the increased velocity of ego vehicle 400, the following gap between ego vehicle 400 and preceding vehicle 402 is insufficient, e.g., according to default ACC operation. Accordingly, ACC operation would typically result in a harsh deceleration of ego vehicle 400 to avoid crashing into/approaching dangerously close to preceding vehicle 402.

In contrast, and in accordance with one embodiment of the disclosed technology, however, ego vehicle 400's monitoring of neighboring vehicle 401 (either when it is in a proximate, but different lane or when they are in the same lane, and neighboring vehicle 401 has become a preceding vehicle to ego vehicle 400) ego vehicle 400 may determine that neighboring vehicle 401 is exhibiting undesirable driving behavior(s). Accordingly, if ACC is already enabled in ego vehicle 400, the selective ADAS control unit of ego vehicle 400 (which may be an embodiment of selective ADAS control unit 220) may adjust its following gap parameter to increase and/or its velocity to decrease instead of imitating the speed of neighboring vehicle 401. Accordingly, following the same example, in the event that neighboring vehicle 401 switches lanes, returning preceding vehicle 402 to its previous preceding vehicle status, the following gap will no longer be insufficient, and harsh deceleration will not be necessary.

As noted above, embodiments of the disclosed technology can operate beyond just addressing individual vehicle control actions (e.g., adjust braking, changing acceleration, etc.) for a particular, observed event/condition/behavior. For example, an ego vehicle may effect some adjustment to its own ADAS, but in many scenarios, it is likely to have other neighboring vehicles. These other neighboring vehicles, in accordance with some embodiments, can also be made to adjust ADAS in a coordinated manner. Further still, embodiments of the disclosed technology can perceive or infer movement patterns of a subject vehicle, e.g., the vehicle being observed as exhibiting undesirable driving behavior(s) over time. In this way, adjustments to ADAS (or selective enablement of ADAS) can better counteract undesirable driving behavior(s).

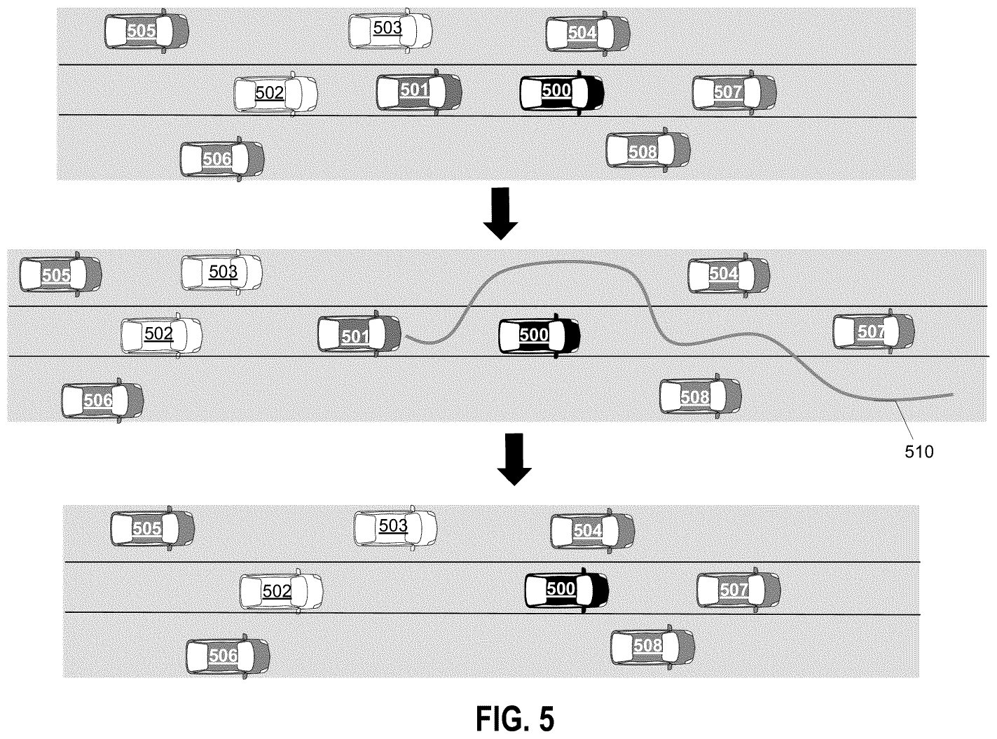

FIG. 5 illustrates an example scenario in which a subject vehicle 501 may be “nudging” (closely approaching from any direction) an ego vehicle 500 at a high speed. Selective ADAS control unit 220 may determine (as described above) that multiple observed nudges by subject vehicle 501 at some threshold speed suggests aggressive driving (an undesirable driving behavior). While ego vehicle 500 and lag vehicle 502 may be able to adjust their respective ADAS parameters to account for subject vehicle 501's aggressive driving, other neighboring vehicles (503-508) may not be aware of subject vehicle 501's aggressive driving. Nevertheless, any one or more of vehicles 503-508 may be at risk of a side or rear-end collision (either by subject vehicle 501, or another vehicle(s) as a result of the aggressive driving of subject vehicle 501).

As described above, various determination units of selective ADAS control unit 220 may be used to determine whether or not a subject vehicle, here, vehicle 501, is exhibiting undesirable driving behavior(s). In this example, a machine learning model may be used to perceive or infer movement patterns associated with subject vehicle 501, in this case, multiple nudges, followed by lane weaving. In some embodiments the machine learning model may be implemented in or as one of the aforementioned determination units, but in other embodiments, vehicles, such as ego vehicle 500 and lag vehicle 502, may interact with a remote server in which the machine learning model may be implemented. In some embodiments, and in conjunction with communication mechanisms (communication unit 217, for example), such as V2V communications mechanisms present in vehicles, or V2I communications mechanisms, for example, can be leveraged to relay information, e.g., driving behavior determinations, to other vehicles. For example, ego vehicle 500 may make such a determination regarding the driving behavior of subject vehicle 501 (either through it's own, resident determination unit or by accessing a remote server/implementation of a determination unit), and may relay that information to lag vehicle 502.

As also described above, embodiments of the disclosed technology can effectuate coordinated or cooperative ADAS operation/adjustment/enablement. In this example, ego vehicle 500 and lag vehicle 502 may assess subject vehicle 501's driving behavior(s), and coordinate ADAS between the other neighboring vehicles. For example, upon determining updated ADAS parameters (using a selective ADAS control unit 220), lag vehicle 502 and ego vehicle 501 can respectively coordinate ADAS parameter adjustment with other neighboring vehicles. Lag vehicle 502 may coordinate ADAS parameter adjustment between itself and neighboring vehicles 503, 505, and 506, while ego vehicle 500 may coordinate ADAS parameter adjustment between itself and neighboring vehicles 504, 507, and 508 (although any grouping/manner of coordination may be performed as appropriate). Here, the coordination between lag vehicle 502 and vehicles 503, 505, and 506 is appropriate given the location or position of these vehicles relative to subject vehicle 501. The same holds true for ego vehicle 500, and vehicles 504, 507, and 508). For example, vehicles 504, 507, and 508, along with ego vehicle 500 precede subject vehicle 501, and thus, can be assumed to experience the undesired driving behavior(s) of subject vehicle 501 in the same/or similar manner, and should likely react (adjust ADAS parameters in this example) in kind as well. Again, communication mechanisms already present in the vehicles or infrastructure (nearby or remote) may be leveraged to, in this example, share the adjusted ADAS parameters amongst themselves, achieving coordinated ADAS operation between multiple vehicles.

It should be understood that shared, adjusted ADAS parameters may be used as-is, without modification in some embodiments, when possible. However, in other scenarios, the sometimes small differences in location/position of a vehicle relative to another vehicle can impact ADAS operation, in which case, each individual vehicle may received shared ADAS parameters, which it may then further adjust or tailor to that particular vehicle's location, position, mode of operation, etc., For example, differences in individual vehicle speeds may warrant individually adjusted ADAS parameters to avoid propagating undesirable driving behavior(s). For example, respective selective ADAS control units of each of these vehicles may take into consideration other obstacles, driving behavior(s) of still other vehicles that may be specific only to that vehicle.

As noted above, subject vehicle 501 may be observed or inferred/predicted to also weave amongst the neighboring vehicles/lanes (shown by line 510). Accordingly, lag vehicle 502 may, in response to its determinations regarding the driving behavior(s) of subject vehicle 501, may initiate coordinated ADAS operation between itself and neighboring vehicles 503, 505, and 506, to reduce the speed of neighboring vehicles 505 and 506. Lag vehicle 502 may then inform/share this determination/ADAS adjustment with ego vehicle 500. In turn, ego vehicle 500 can adjust the ADAS operation of neighboring vehicles 504, 507, and 508 (each of which precede ego vehicle 500). For example, ego vehicle 500 may adjust its own ADAS parameters/make its own ADAS adjustment determinations, and neighboring vehicles 504, 507, and 508, may make further adjustments to effectuate increased distance between them and subject vehicle 501, so that the aggressive driving behavior(s) of subject vehicle 501 can be accounted for/avoided, and the propagation of subject vehicle 501's undesirable driving behavior(s) can be avoided. Upon passage of subject vehicle 501, the respective ADAS of each of neighboring vehicles 503-508, and ego vehicle 500, and lag vehicle 502, can be reset/returned to a default mode or operation.

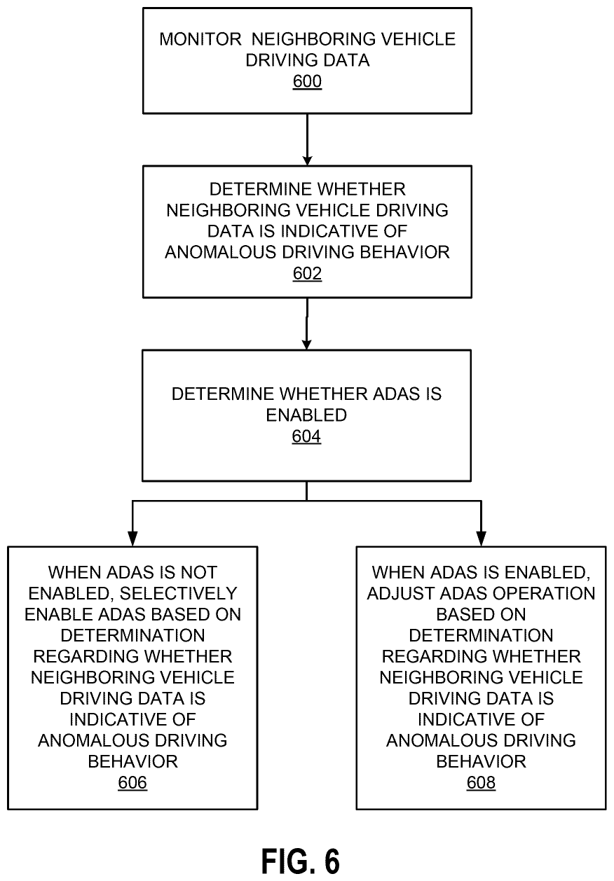

FIG. 6 is a flow chart illustrating example operations that may be performed to implement driving behavior-aware ADAS.

At operation 600, driving data of a neighboring vehicle is monitored. As described above, a neighboring vehicle can be any vehicle that is proximate to the vehicle in which driving behavior-aware ADAS is implemented, e.g., a preceding vehicle, a vehicles in a neighboring lane, and so on. Monitoring a vehicle's driving data may involve that vehicle's sensors, e.g., external sensors, sensing neighboring vehicles speed, acceleration/deceleration events, lane change events, etc. In some embodiments, driving data may be obtained from other sources, e.g., service providers, other vehicles, roadway infrastructure, and the like. Also, as discussed above, multiple vehicles in the vicinity of/proximate to a neighboring vehicle can sense and share relevant driving data with an ego vehicle as well. Unlike conventional ADAS implementations, that merely adjust an ego vehicle's operation profile to match that of a neighboring vehicle, embodiments of the disclosed technology sense and analyze the driving data associated with neighboring vehicles to determine whether or not to enable (or how to adjust) ADAS operation.

At operation 602, a determination can be made as to whether the neighboring vehicle's driving data is indicative of anomalous (or undesired) driving behavior. This determination can be made using, e.g., machine learning, where a trained machine learning model can perceive whether or not a neighboring vehicle is exhibiting undesirable driving behavior according to its training. In other embodiments, this determination can be made by a processor/computing component/circuitry for comparing ADAS operating parameters of the neighboring vehicle to particular thresholds that when met or exceeded (or not met) depending on the implementation, indicate anomalous driving behavior(s). In still other embodiments, as discussed above, movement patterns, repetitive actions, and the like that may be unique to or indicative of undesirable driving behavior can be inferred or predicted as well. Instead of singular events or behaviors, such patterns or actions over time can be used as inputs to selective ADAS control units to determine appropriate responses, whether ADAS parameter adjustment, or selective ADAS enablement. For example, certain vehicle behaviors can be characterized and organized according to certain movement patterns, and such information can be used to train an appropriate machine learning algorithm to create a machine learning model capable of interpreting vehicle actions as movement patterns suggestive of various driving behaviors. Other mechanisms for determining movement patterns, recognizing or perceiving driving behaviors, may be used.

For example, distance-to-lane marker observations may be made (e.g., by connected vehicles capable of communicating amongst each other/roadway infrastructure/etc.). Deviant driving behavior may be filtered out based on the distance-to-lane marker observations for further analysis to infer distinctive movement patterns unique to undesired/anomalous driving behavior. Distance-to-collision measurements can be used, and time-series analysis (via, e.g., a contrast profile tool that compares, e.g., two instances/sets of time-series data to reveal contrasting driving behavior between them) can be performed to deduce movement patterns occurring before and after driving events/times during which undesirable driving behavior is exhibited. A data repository may be used to store determined movement patterns, which can be shared with, e.g., connected vehicles, which can compare observed driving data with the stored movement patterns to detect undesirable driving behavior in real-time/near-real time.

At operation 604, a determination is made regarding whether ADAS is enabled. Autonomous control system 200 is aware of whether or not it is being used in the vehicle in which it is implemented. For example, in accordance with one embodiment, when control unit receives determinations/recommendations from determination/recommendation unit 222, autonomous control system can infer ADAS is enabled/active. As discussed above, operations that are performed in response to determining that a neighboring vehicle(s) is exhibiting/engaging in undesirable behavior, such as speeding, unnecessary/frequent lane changing, harsh acceleration/deceleration events, etc. may depend on whether or not ADAS is already enabled.

At operation 606, when ADAS is not enabled, ADAS is selectively enabled based on the determination regarding whether or not the neighboring vehicle's driving data is indicative of anomalous behavior (per operation 502). In the event that the neighboring vehicle is driving in an anomalous manner and ADAS is not yet enabled, determination/recommendation unit 222 (FIG. 2) may instruct control unit 216 to prohibit the enablement or activation of the ADAS. This is because, as discussed above, allowing conventional ADAS to operate would result in the vehicle at issue imitating undesirable behavior(s) of the neighboring vehicle. This is turn, could make passengers of the vehicle at issue feel some level/type(s) of discomfort. Moreover, the passengers may ultimately disable ADAS preventing ADAS from working even in scenarios when no neighboring vehicle is exhibiting undesired driving behavior(s).

At operation 608, when ADAS is enabled, ADAS operation is adjusted based on the determination regarding whether the neighboring vehicle's driving data is indicative of anomalous driving behavior. As discussed above, adjusting ADAS operation can involve adjusting operating parameters to offset or compensate for the undesired driving behavior(s) or the result(s) of such undesired driving behavior(s). In this way, the undesired driving behavior(s) of the neighboring vehicle is not imitated, thereby preventing or mitigating the propagation of undesired driving behavior(s). As also discussed above, ADAS adjustments can be made according to observed movement patterns of a subject vehicle. Moreover, the ADAS adjustments to be made need not be limited to a single, e.g., ego, vehicle. Rather, coordinated or cooperative ADAS adjustments/operation can be effectuated in accordance with various embodiments between a plurality of neighboring vehicles.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

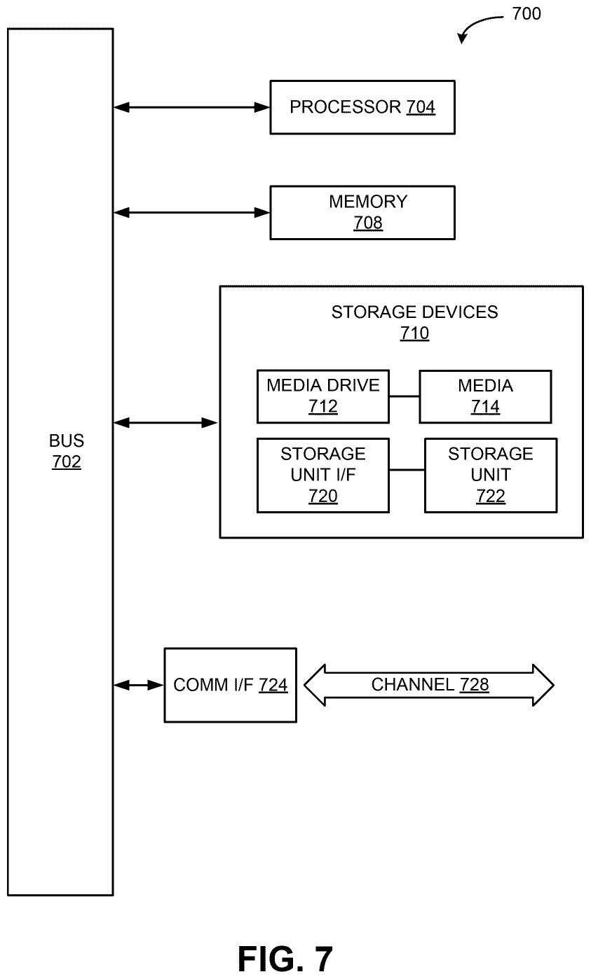

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability. In accordance with some embodiments, computing component 700 may embody any one or more of the components, systems, or elements of autonomous control system 200, and selective ADAS control unit 220.

Computing component 700 might include, for example, one or more processors, controllers, control components, or other processing devices. This can include a processor 704. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 602 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle comprising:
an autonomous control system adapted to provide one or more commands to autonomously control one or more systems of the vehicle; and
an autonomous control unit adapted to selectively enable the autonomous control system in response to a determination regarding whether a neighboring vehicle, whose associated driving data influences the autonomous control system of the vehicle, is exhibiting anomalous driving behavior.

2. The vehicle of claim 1, wherein the autonomous control system comprises an advanced driver assistance system.

3. The vehicle of claim 1, wherein the autonomous control unit comprises a determination component adapted to determine whether the associated driving data of the neighboring vehicle is suggestive of anomalous driving behavior.

4. The vehicle of claim 3, wherein the determination component comprises a machine learning model trained to perceive anomalous driving behavior based on input data comprising the neighboring vehicle driving data.

5. The vehicle of claim 3, wherein the determination component comprises a processor adapted to compare the associated driving data with threshold data, which when exceeded suggests that the neighboring vehicle is exhibiting anomalous driving behavior.

6. The vehicle of claim 5, wherein the associated driving data comprises one or more movement patterns of the neighboring vehicle.

7. The vehicle of claim 1, wherein the autonomous control unit is further adapted to selectively adjust default operation of the autonomous control system when the autonomous control system is already enabled.

8. The vehicle of claim 7, wherein selective adjustment of the default operation of the autonomous control system comprises generating and offsetting parameters used to effectuate a resulting operation of the autonomous control system that counters exhibited anomalous driving behavior.

9. A vehicle comprising:
an autonomous control system adapted to provide one or more commands to autonomously control one or more systems of the vehicle; and
an autonomous control unit adapted to selectively adjust default operation of the autonomous control system in response to a determination regarding whether a neighboring vehicle, whose associated driving data influences the autonomous control system of the vehicle, is exhibiting anomalous driving behavior.

10. The vehicle of claim 9, wherein the autonomous control system comprises an advanced driver assistance system.

11. The vehicle of claim 9, wherein the autonomous control unit comprises a determination component adapted to determine whether the associated driving data of the neighboring vehicle is suggestive of anomalous driving behavior.

12. The vehicle of claim 11, wherein the determination component comprises a machine learning model trained to perceive anomalous driving behavior based on input data comprising the neighboring vehicle driving data.

13. The vehicle of claim 11, wherein the determination component comprises a processor adapted to compare the associated driving data with threshold data, which when exceeded suggests that the neighboring vehicle is exhibiting anomalous driving behavior.

14. The vehicle of claim 13, wherein the associated driving data comprises one or more movement patterns of the neighboring vehicle.

15. The vehicle of claim 9, wherein the selective adjustment of the default operation of the autonomous control system comprises offsetting parameters used to effectuate a resulting operation of the autonomous control system that counters exhibited anomalous driving behavior.

16. A vehicle, comprising:
a processor; and
a memory unit operatively connected to the processor and including computer code, that when executed, causes the processor to:
monitor driving data associated with a neighboring vehicle proximate to the vehicle;
determine whether the neighboring vehicle's driving data is indicative of anomalous driving behavior;
determine whether an driver assistance system of the vehicle is enabled; and
when the driver assistance system is not enabled, selectively enable the driver assistance system based on a determination regarding whether driving data associated with the neighboring vehicle is indicative of anomalous driving behavior; and
when the driver assistance system is enabled, adjust operation of the driver assistance system based on the determination regarding whether driving data associated with the neighboring vehicle is indicative of anomalous driving behavior.

17. The vehicle of claim 16, wherein the computer code causing the processor to determine whether the neighboring vehicle's driving data is indicative of anomalous driving behavior comprises a machine learning model trained to perceive anomalous driving behavior based on input data comprising the driving data associated with the neighboring vehicle.

18. The vehicle of claim 16, wherein the computer code causing the processor to determine whether the neighboring vehicle's driving data is indicative of anomalous driving behavior further causes the processor to compare the associated driving data with threshold data, which when exceeded suggests that the neighboring vehicle is exhibiting anomalous driving behavior.
